(19) United States
(12) Patent Application Publication
(10) Pub. No.: US 2025/0183308 A1
(43) Pub. Date: Jun. 5, 2025

(54) COMPOSITION FOR BINDER OF ALL-SOLID-STATE BATTERY, AND ELECTRODE AND BATTERY INCLUDING THE SAME

(71) Applicant: Electronics and Telecommunications Research Institute, Daejeon (KR)

(72) Inventors: Jaecheol CHOI, Daejeon (KR); Young-Gi LEE, Daejeon (KR); Seok Hun KANG, Daejeon (KR); Ju Young KIM, Daejeon (KR); Dong Ok SHIN, Daejeon (KR); Myeong Ju LEE, Daejeon (KR)

(21) Appl. No.: 18/963,408

(22) Filed: Nov. 27, 2024

(30) Foreign Application Priority Data
Nov. 30, 2023 (KR) 10-2023-0171107
Mar. 14, 2024 (KR) 10-2024-0035895

(51) Int. Cl. H01M 4/62; C08F 220/44; C08F 236/06; H01M 10/0562; H01M 10/0585

(52) U.S. Cl. CPC H01M 4/622; C08F 220/44; C08F 236/06; H01M 10/0562; H01M 10/0585; H01M 2300/0068; H01M 2300/008

(57) ABSTRACT

Provided is a composition for a binder of an all-solid-state battery, and more specifically, to a composition for a binder of an all-solid-state battery in that a lithium salt and a nitrile-based polymer are contained, the lithium salt and the nitrile-based polymer are coordinated, and an amount of the lithium salt is about 0.1 wt % and more, and less than about 1 wt % on the basis of the total weight of the composition.

### CROSS-REFERENCE TO RELATED APPLICATIONS

This U.S. non-provisional patent application claims priority under 35 U.S.C. § 119 of Korean Patent Application Nos. 10-2023-0171107, filed on Nov. 30, 2023, and 10-2024-0035895, filed on Mar. 14, 2024, the entire contents of which are hereby incorporated by reference.

### BACKGROUND

The present disclosure herein relates to a composition for a binder, and an electrode and a battery including the same.

A solid electrolyte has been developed for securing stability of a lithium-ion battery. A ceramic-based solid electrolyte that also functions as a separator simplifies a battery structure, has no risk of leakage, fire, explosion and the like from the electrolyte, and has excellent electrochemical stability, which allows for the use of high-voltage electrodes without limitation. In addition, the solid-state electrolyte may use a lithium metal having theoretical capacity more than 10 times that of graphite materials which have been commercialized as a traditional negative electrode material, use of the solid-state electrolyte may be expanded to an electrolyte for a lithium-air battery or lithium-sulfur battery. Therefore, energy density for mass and volume may be significantly improved.

The sulfide-based solid electrolyte is a compound on the basis of a sulfide ion which has a relatively large size and high polarity, and includes glass-ceramic Li₂S—P₂S₅, thio-LISICON Li_{3.25}Ge_{0.25}P_{0.75}S₄, Li₁₀GeP₂Si₂, Argyrodite, etc., as representative examples thereof. In addition, the sulfide-based solid electrolyte has high lithium-ion conductivity in the range of 10⁻³˜10⁻² S/cm, approaching that of a liquid electrolyte at room temperature. In a case of the sulfide-based solid electrolyte, formation of grain boundaries may be easily minimized through a cold pressing process alone due to soft properties of the material, and thus processability is excellent during preparation of the all-solid-state battery. However, the sulfide-based solid electrolyte is mainly composed of thiophosphate (PS4³⁻) having an unstable structure, which causes a limitation in that the sulfide-based solid electrolyte easily reacts with moisture in air and a compound having polarity and thus an original phase collapses. Therefore, in the preparation process of the electrode including the sulfide solid electrolyte, selection of the active material, binder, and conductive material calls a considerable attention. Particularly, the nitrile-based binder is mainly used as a binder for the sulfide-based all-solid-state battery due to the advantage of being easily soluble in a nonpolar solvent, but a polar nitrile group forming the binder is known to cause a side reaction during the electrode preparation process and the battery evaluation, resulting in an increase in resistance and a decrease in performances of the battery.

In the case of the binder including the nitrile group, which has been mainly used as a binder for the typical sulfide-based all-solid-state battery, when driving the battery at high temperature, performances of the battery is known to be reduced via the nitrile side reaction. Therefore, there is a need for developments on the nitrile-based binder that improves the performance of the battery and maintains high mechanical properties.

### SUMMARY

The present disclosure provides a composition for a binder constituting an all-solid-state battery having high charge-discharge efficiency, and an electrode and a battery including the same.

An embodiment of the inventive concept provides a d composition for a binder of an all-solid-state battery including a lithium salt and a nitrile-based polymer, wherein the lithium salt and the nitrile-based polymer are coordinated, and an amount of the lithium salt is about 0.1 wt % or more and less than about 1 wt % on the basis of the total weight of the composition.

In an embodiment, the lithium salt may include at least one among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI and LiPDI.

In an embodiment, a weight average molecular weight of the nitrile-based polymer may be about 5,000 to about 10,000,000.

In an embodiment, the sulfide-based solid electrolyte may include PS₄³⁻ anions.

In an embodiment, the sulfide-based solid electrolyte may include at least one among a LPS solid electrolyte and a LPSCI solid electrolyte.

In an embodiment, the nitrile-based solid polymer may be polyacrylonitrile.

In an embodiment, the nitrile-based polymer may be a copolymer prepared from a first monomer and a second monomer, the first monomer may be acrylonitrile, and the second monomer may be a monomer that includes no nitrile functional group.

In an embodiment, the second monomer may be butadiene.

In an embodiment, the solvent may include at least one among water, ethanol, acetone, isopropyl alcohol, hexane, heptane, nonane, decane, benzene, toluene, xylene, anisole, cyclohexanone, methyl ethyl ketone, tetrahydrofuran, N-methyl pyrrolidone, hexamethyl phosphor amide, dioxane, tetramethyl urea, triethyl phosphate, trimethyl phosphate, dimethyl formamide, dimethyl sulfoxide and dimethyl acetamide.

In an embodiment of the inventive concept, an electrode for an all-solid-state battery includes a binder, and a sulfide-based solid electrolyte, wherein, the binder includes a lithium salt and a nitrile-based polymer, the lithium salt and the nitrile-based polymer are coordinated, and an amount of the lithium salt is about 0.1 wt % or more and less than about 1 wt % on the basis of the total weight of the binder.

In an embodiment of the inventive concept, a rechargeable battery includes a positive electrode, a negative electrode; and a solid electrolyte disposed therebetween, at least one among the positive electrode and the negative electrode includes a binder and a sulfide-based solid electrolyte, the binder includes a lithium salt and a nitrile-based polymer, the lithium salt and the nitrile-based polymer are coordinated, and an amount of the lithium salt is about 0.1 wt % or more and less than about 1 wt % on the basis of the total weight of the binder.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 illustrates a binder structure for an all-solid-state battery according to Example 1;

FIG. 2 illustrates an electrode structure of a sulfide-based all-solid-state battery according to Example 2;

FIG. 3 illustrates an electrode structure of a sulfide-based all-solid-state battery according to Comparative Example 2;

FIG. 4 shows analysis results on nitrile-lithium coordinate covalent bond of nitrile-based binders according to Comparative Example 1, Example 1-1, Example 1-2, Example 1-3, and Example 1-4; and

FIG. 5 shows initial charge-discharge results of sulfide-based all-solid-state batteries according to Comparative Example 2 and Example 2.

### DETAILED DESCRIPTION

Preferable embodiments of the inventive concept will be described with reference to accompanying drawings in order to sufficiently understand configuration and effect of the inventive concept. However, the inventive concept is not limited to embodiments disclosed hereinafter, and may be implemented in various forms and various modifications may be made. However, the embodiments of the inventive concept are provided only to complete the disclosure of the invention and to thoroughly convey the full scope of the invention to those who ordinary skilled in the art. The accompanying drawings illustrate the components on an enlarged scale compared to the actual size thereof for convenience of explanation, and the ratios of the components may be exaggerated or reduced.

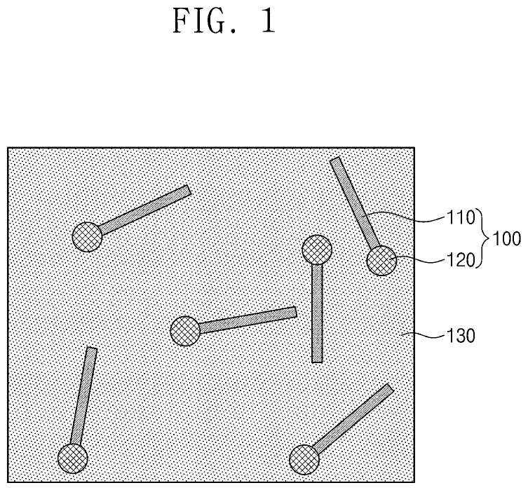

FIG. 1 illustrates a binder structure for an all-solid-state battery according to Example 1.

Referring to FIG. 1, a binder composition for an all-solid-state battery according to an embodiment of the inventive concept may include a binder 100 and a solvent 130. The binder 100 may include a nitrile-based polymer 110 and a lithium cation 120. The nitrile-based polymer 110 and the lithium cation 120 may be coordinated.

The nitrile-based polymer 110 may mean a polymer having a repeating unit that includes a nitrile functional group. The nitrile-based polymer 110 may have a weight average molecular weight of about 5,000 to about 10,000,000.

The nitrile-based polymer 110 may be a homopolymer. The nitrile-based polymer 110 may be prepared from, for example, one monomer including a nitrile functional group. The nitrile-based polymer 110 may be, for example, polyacrylonitrile, and the one monomer may be, for example, acrylonitrile.

The nitrile-based polymer 110 may be a copolymer. The nitrile-based polymer 110 may be prepared by, for example, a first monomer that has a nitrile functional group and a second monomer that has no nitrile functional group. The first monomer may be, for example, acrylonitrile. The second monomer may include, for example, at least one among ethylene, propylene, butadiene, ethylene terephthalate, butylene terephthalate, styrene, vinyl methacrylate, vinyl chloride, carbonate, methyl methacrylate, tetrafluoroethylene, vinylidene fluoride, hexafluoropropylene, etherimide, oxymethylene, siloxane, sulfone, etheretherketone, glucose and ethyl glucoside. The second monomer may include, for example, at least one among epoxy, phenol, and imide compounds.

In an embodiment, the nitrile-based polymer 110 may be an acrylonitrile-butadiene-styrene (ABS) copolymer, or an acrylonitrile-butadiene (AB) copolymer. In an embodiment, the nitrile-based polymer 110 may be an acrylonitrile-butadiene (AB) copolymer. In an embodiment, the nitrile-based polymer 110 may be represented by Formula 1 below.

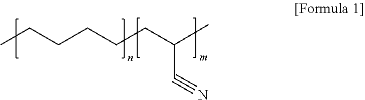

where, n may be 1 to 100,000, m may be 1 to 100,000, and Formula 1 above may be a copolymer in a block, alternating, or random type.

The binder 100 may further include a polymer that has no nitrile functional group. The polymer that has no nitrile functional group may be, for example, a homopolymer. The polymer that has no nitrile functional group may include, for example, at least one among polyethylene, polypropylene, polybutadiene, polyethylene terephthalate, polybutylene terephthalate, polystyrene, polyvinyl methacrylate, polyvinyl chloride, polycarbonate, polymethyl methacrylate, polytetrafluoroethylene, polyvinylidene fluoride, polyhexafluoropropylene, polyetherimide, polyoxymethylene, polysiloxane, polysulfone, polyethersulfone, polyetheretherketone, cellulose, and ethyl cellulose. The polymer that has no nitrile functional group may include, for example, at least one among polyimide, an epoxy polymer, a phenol polymer, and a nylon-based polymer.

The polymer that has no nitrile functional group may be, for example, a copolymer. The polymer that has no nitrile functional group may be, for example, a styrene butadiene (SB) copolymer.

The lithium cation 120 may be contained in the binder 100 in the form of a lithium salt. An amount of the lithium salt may be about 0.01 wt % and more, and less than about 1 wt % on the basis of a total weight of the binder 100. The lithium salt may include at least one among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI and LiPDI.

The solvent 130 may include at least one among water, ethanol, acetone, isopropyl alcohol, hexane, heptane, nonane, decane, benzene, toluene, xylene, anisole, cyclohexanone, methyl ethyl ketone, tetrahydrofuran, N-methyl pyrrolidone, hexamethyl phosphor amide, dioxane, tetramethyl urea, triethyl phosphate, trimethyl phosphate, dimethyl formamide, dimethyl sulfoxide and dimethyl acetamide.

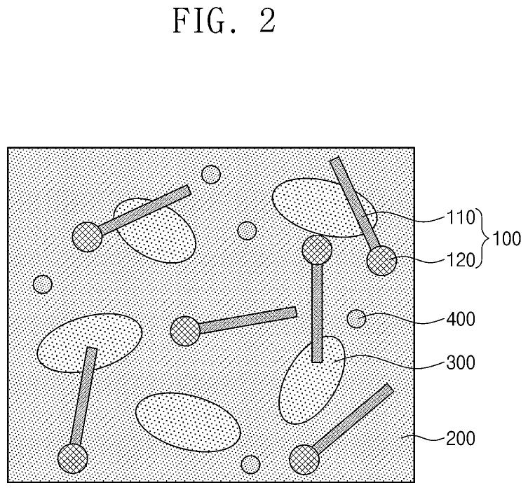

FIG. 2 illustrates an electrode structure of a sulfide-based all-solid-state battery according to Example 2. The duplicated descriptions with those described in FIG. 1 will be omitted apart from what will be described below.

Referring to FIG. 2, the sulfide-based all-solid-state battery according to an embodiment of the inventive concept may include a binder 100, a sulfide-based solid electrolyte 200, an active material 300, and a conductive material 400.

An amount of the binder 100 may be about 0.1 wt % to about 5 wt % on the basis of the total weight of the electrode. Although not illustrate, in the electrode, the binder 100 may be contained in the form of a composition, and in this case, a solvent 130 may be further included in the electrode.

The sulfide-based solid electrolyte 200 may include a solid electrolyte including PS₄³⁻ ions according to Formula 2 below. The sulfide-based solid electrolyte 200 may include, for example, at least one among LPS solid electrolyte and LPSCI solid electrolyte. An amount of the sulfide-based solid electrolyte 200 may be about 8 wt % to about 40 wt % on the basis of the total weight of the electrode.

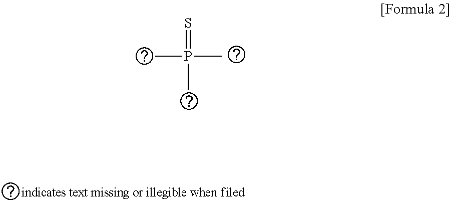

In the electrode according to an embodiment of the inventive concept, a nitrile group of the nitrile-based polymer 100 represented by Formula 1 above and a lithium cation 120 may be coordinated. Therefore, since the nitrile group becomes electron-deficient, a side reaction of the sulfide-based solid electrolyte 200 with PS₄³⁻ ions according to Formula 2 above is suppressed, and thus improved charge-discharge efficiency may be shown.

An amount of the active material 300 may be about 50 wt % to about 91.9 wt %. The active material 300 may be a positive electrode active material or a negative electrode active material. The positive electrode active material may include at least one among sulfur, LiCoO₂, LiNiO₂, LiNiₓCo_{y}Mn_{z}O₂ (where, x>0, y>0, z>0 and x+y+z=1), LiMn₂O₄ and LiFePO₄. The negative electrode active material may include at least one among silicon, tin, graphite, and lithium.

An amount of the conductive material 400 may be about 0 wt % to about 5 wt %. The conductive material 400 may include at least one among carbon black, carbon nanotube, and graphene. The carbon black may be, for example, Super P.

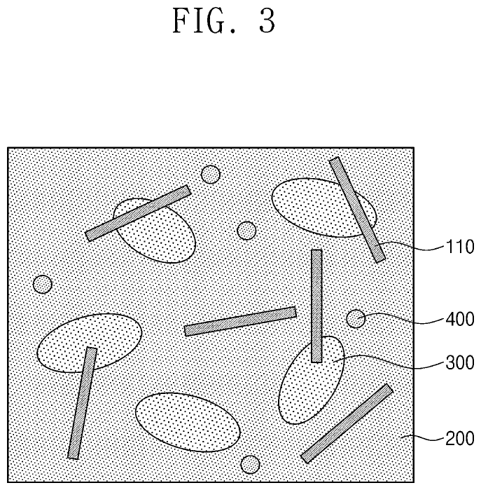

FIG. 3 illustrates an electrode structure of a sulfide-based all-solid-state battery according to Comparative Example 2. The electrode of the sulfide-based all-solid-state battery according to Comparative Example 2 is similar as the electrode of the sulfide-based all-solid-state battery according to Example 2 except that the lithium cation 120 is not coordinated to the binder 100 in the electrode of the sulfide-based all-solid-state battery according to Comparative Example 2. The duplicated descriptions with those described in FIG. 1 and FIG. 2 will be omitted apart from what will be described below.

The electrode of the sulfide-based all-solid-state battery according to Comparative Example 2 may include no lithium cation 120. Therefore, the nitrile group of the nitrile-based polymer 110, represented by Formula 2 above may be electron-sufficient, and the PS₄³⁻ ions of the solid electrolyte 200, represented by Formula 2 above, may become electron-deficient. Therefore, the side reaction between the nitrile group represented by Formula 1 above and the PS₄³⁻ ions represented by Formula 2 above may occur, and thus charge-discharge efficiency may be relatively lowered.

### Preparation of Nitrile-Based Binder Solution

### Example 1-1

A LiTFSI salt as a lithium salt and an acrylonitrile-butadiene (AB) copolymer as a polymer were used. Anisole was used as a solvent. The lithium salt, the polymer, and the solvent were mixed to prepare a nitrile-based binder solution such that an amount of the LiTFSI salt is to be about 0.25 wt % on the basis of the total weight of the binder.

### Example 1-2

A nitrile-based binder solution was prepared in the same manner as Example 1-1 except that the amount of the LiTFSI salt was about 0.5 wt % on the basis of the total weight of the binder.

### Example 1-3

A nitrile-based binder solution was prepared in the same manner as Example 1-1 except that the amount of the LiTFSI salt was about 0.75 wt % on the basis of the total weight of the binder.

### Example 1-4

A nitrile-based binder solution was prepared in the same manner as Example 1-1 except that the amount of the LiTFSI salt was about 1 wt % on the basis of the total weight of the binder.

### Example 1-5

A nitrile-based binder solution was prepared in the same manner as Example 1-1 except that the amount of the LiTFSI salt was about 3 wt % on the basis of the total weight of the binder.

### Comparative Example 1

A nitrile-based binder solution was prepared, which includes no lithium salt and includes the acrylonitrile-butadiene (AB) copolymer alone.

### Preparation of all-Solid-State Battery

### Example 2

An all-solid-state battery was prepared which includes a negative electrode and a composite positive electrode and a solid electrolyte was disposed between the negative electrode and the composite positive electrode. A lithium metal having a thickness of about 300 mm was used as the negative electrode, and a lithium phosphorus sulfur chloride (LPSCl) compound was used as the solid electrolyte.

The composite positive electrode was prepared by mixing a positive electrode active material, a solid electrolyte, a binder, a conductive material. A LiCoO₂ (LCO) compound, on which LiNbO₃ was applied, was used as the positive electrode active material, the nitrile-based binder solution according to Example 1-2 was used as the binder, and a Super-P conductive material was used as the conductive material.

The positive electrode active material:solid electrolyte:binder:conductive material were stirred in the anisole solvent at a weight ratio of about 60:35:2:3. The prepared slurry according to this was applied onto a nickel current collector, and then dried to prepare a positive electrode having a final thickness of about 65 □m.

The composite positive electrode and the negative electrode were respectively bonded, through pressurization, to both sides of the solid electrolyte to prepare the all-solid-state battery.

### Comparative Example 2

An all-solid-state battery was prepared in the same manner in Example 2 except that the nitrile-based binder solution according to Comparative Example 1 was used as a binder.

Evaluation results the binder solutions according to Comparative Example 1, Example 1-2, Example 1-4, and Example 1-5 were listed in Table 1.

TABLE 1

| | Evaluation Results |
|---|---|
| Comparative Example 1 | Excellent |
| Example 1-2 | Excellent |
| Example 1-4 | Average |
| Example 1-5 | Poor |

(Excellent: a state where aggregation in the solution is not visually observable,
Average: a state where aggregation in the solution is observed in less than about 5% of the solution volume,
Poor: a state where aggregation in the solution is observed in at least about 5% of the solution volume)

Compared the binder solution according to Example 1-2 including the lithium salt of about 0.5 wt %, with the binder solution according to Example 1-4 including the lithium salt of about 1 wt % and the binder solution according to Example 1-5 including the lithium salt of about 3 wt %, it can be confirmed that, in each of the binder solutions according to Example 1-4 and Example 1-5 respectively including the lithium salt of about 1 wt % and about 3 wt %, the lithium salt and the nitrile-based polymer were aggregated, and thus each of the binder solutions according to Example 1-4 and Example 1-5 is unsuitable for the nitrile-based binder solution.

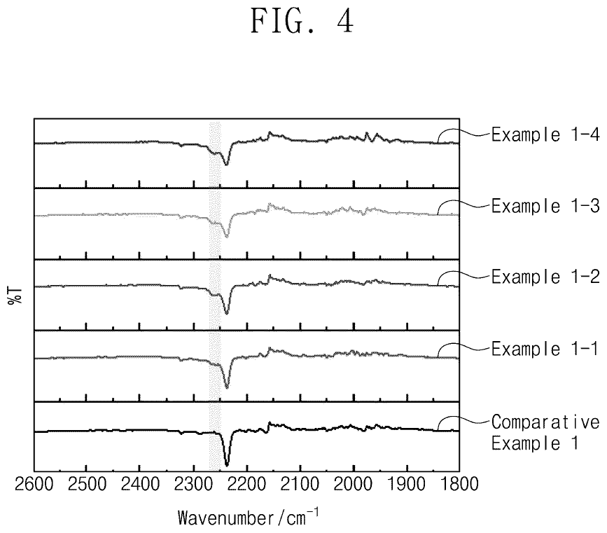

FIG. 4 shows FT-IR analysis results on the nitrile-based binders according to Example 1-1, Example 1-2, Example 1-3, and Example 1-4.

According to the FT-IR analysis results, it can be confirmed that as the weight of the lithium salt increases in the binder, nitrile-lithium coordinate covalent bond (bond frequency: about 2260 cm¹) increases.

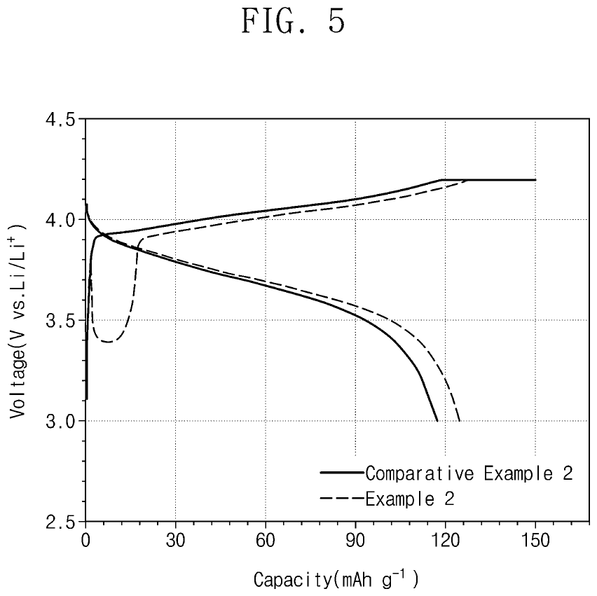

FIG. 5 shows evaluation results on initial charge-discharge of the sulfide-based all-solid-state batteries according to Comparative Example 2 and Example 2. A charge capacity (mAh/g), a discharge capacity (mAh/g), and charge-discharge efficiency (%) of each of the sulfide-based all-solid-state batteries according to Comparative Example 2 and Example 2 are listed in Table 2.

The evaluation on charge-discharge was performed using a charger-discharger at a current density of about 0.1 mA/cm².

TABLE 2

| | Charge | Discharge | Charge- |
|---|---|---|---|
| | capacity | capacity | discharge |
| | (mAh/g) | (mAh/g) | efficiency (%) |
| Comparative Example | 151 | 117 | 78.2 |
| 2 | | | |
| Example 2 | 137 | 120 | 87.7 |

Referring to FIG. 4 and Table 2, it can be confirmed that the battery according to Example 2 has more improved charge-discharge efficiency (%) than that according to Comparative Example 2. This is due to the fact that the side reaction between the nitrile-based binder and the sulfide solid electrolyte is suppressed.

According to the concept of the inventive concept, the binder coordinates the nitrile group with lithium ions, and thus output characteristics of the sulfide-based all-solid-state battery may be improved while minimizing side reaction caused when the battery is driven at high temperatures. Binding characteristics shown in the nitrile group may be maintained at a similar level as the conventional binder, and thus when the electrode including the same is prepared, high mechanical properties may be maintained.

Effects of the present inventive concept is not limited to the effects described hitherto, and other effects that are not described can be clearly understood to those ordinary skilled in the art from the following descriptions.

Although the embodiments of the present invention have been described with reference to attached drawings, various changes and modifications can be made without changing the spirit and scope of the present invention and necessary features as hereinafter claimed.

What is claimed is:

1. A composition for a binder of an all-solid-state battery, comprising:
a lithium salt; and
a nitrile-based polymer,
wherein the lithium salt and the nitrile-based polymer are coordinated, and
an amount of the lithium salt is about 0.1 wt % or more and less than about 1 wt % on the basis of the total weight of the composition.

2. The composition of claim 1, wherein the lithium salt includes at least one among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI and LiPDI.

3. The composition of claim 1, wherein a weight average molecular weight of the nitrile-based polymer is about 5,000 to about 10,000,000.

4. The composition of claim 1, wherein the nitrile-based solid polymer is polyacrylonitrile.

5. The composition of claim 1,
wherein the nitrile-based polymer is a copolymer prepared from a first monomer and a second monomer,
the first monomer is acrylonitrile, and
the second monomer is a monomer that includes no nitrile functional group.

6. The composition of claim 5, wherein the second monomer is butadiene.

7. The composition of claim 1 further comprising a solvent, wherein the solvent includes at least one among water, ethanol, acetone, isopropyl alcohol, hexane, heptane, nonane, decane, benzene, toluene, xylene, anisole, cyclohexanone, methyl ethyl ketone, tetrahydrofuran, N-methyl pyrrolidone, hexamethyl phosphor amide, dioxane, tetramethyl urea, triethyl phosphate, trimethyl phosphate, dimethyl formamide, dimethyl sulfoxide and dimethyl acetamide.

8. An electrode for an all-solid-state battery comprising:
a binder; and
a sulfide-based solid electrolyte,
wherein, the binder includes a lithium salt and a nitrile-based polymer,
the lithium salt and the nitrile-based polymer are coordinated, and
an amount of the lithium salt is about 0.1 wt % or more and less than about 1 wt % on the basis of the total weight of the binder.

9. The composition of claim 8, wherein the sulfide-based solid electrolyte includes anions of PS₄³⁻.

10. The composition of claim 8, wherein the sulfide-based solid electrolyte includes at least one among a LPS solid electrolyte and a LPSCI solid electrolyte.

11. A rechargeable battery comprising:
a positive electrode;
a negative electrode; and
a solid electrolyte disposed therebetween,
wherein at least one among the positive electrode and the negative electrode includes a binder and a sulfide-based solid electrolyte,
the binder includes a lithium salt; and a nitrile-based polymer,
the lithium salt and the nitrile-based polymer are coordinated, and
an amount of the lithium salt is about 0.1 wt % or more and less than about 1 wt % on the basis of the total weight of the binder.
